(19) United States
(12) Patent Application Publication
(10) Pub. No.: US 2014/0016779 A1
(43) Pub. Date: Jan. 16, 2014

(54) TAMPER RESISTANT ELECTRONIC PACKAGES WITH QUANTUM INTERCONNECTS

(71) Applicant: Christopher B. Lirakis, Portsmouth, RI (US)

(72) Inventor: Christopher B. Lirakis, Portsmouth, RI (US)

(73) Assignee: RAYTHEON BBN TECHNOLOGIES CORP., Cambridge, MA (US)

(21) Appl. No.: 13/547,412

(22) Filed: Jul. 12, 2012

(51) Int. Cl. H04L 9/00; H04L 9/08

(52) U.S. Cl. 380/256

(57) ABSTRACT

A method for resisting tampering, the method including discovering a plurality of electronic packages for communication, each of the plurality of electronic packages having an associated quantum state table, mapping a plurality of communications paths among the plurality of electronic packages, for each communication path of the plurality of communications paths, making an entry into the quantum state table, negotiating key material for each of the plurality of communications paths, for a plurality of data exchanges along each of the plurality of communications paths generating a key, and encrypting a data exchange on a communications path with the key.

### BACKGROUND

The present invention relates to tamper resistant packages, and more specifically, to tamper resistant system interconnects implementing quantum protocols.

Current tamper resistant electronic protection typically includes protecting the data that resides within the package. If the electronic package is breached, the information is lost. For example, tamper resistant packages can be designed to zeroise (i.e., erase all sensitive data) the protected data, which can include cryptographic keys residing in the electronic packaging. In addition, if the electronic package's signal paths are probed externally, the package can be designed to lose the data integrity, such as by burning links. Any communication with outside devices from the electronic package, such as memory chips, is encrypted by a cryptographic key. The key is burned into the package at production or programming time. Electronic packages allow for multiple, but a limited number of re-key operations to permit changes in the key over time. As such, the data in the electronic package are protected for a period of time depending on the key length. The key length is determined by the time to crack the code which is mandated by how important the data within the electronic package is deemed. Therefore, a single key may not be sufficient to protect an asset for a period of months or years. It is possible that an intruder has complete knowledge of the system and can insert a malicious module into the system for the purposes of data monitoring or gaining control of the system at a critical time. Current package protection will not prevent or detect such malicious monitoring or control.

### SUMMARY

Exemplary embodiments include a method for resisting tampering, the method including discovering a plurality of electronic packages for communication, each of the plurality of electronic packages having an associated quantum state table, mapping a plurality of communications paths among the plurality of electronic packages, for each communication path of the plurality of communications paths, making an entry into the quantum state table, negotiating key material for each of the plurality of communications paths, for a plurality of data exchanges along each of the plurality of communications paths generating a key, and encrypting a data exchange on a communications path with the key.

Additional exemplary embodiments include a tamper resistant electronic package system, including a crypto coprocessor, including a transmitter configured to generate optical data, a receiver coupled to and configured to exchange optical data between the transmitter, and to generate the electrical data from one or more sources of multiplexed optical data and a quantum key distribution controller coupled to the transmitter and the receiver, the quantum key distribution controller configured to generate a key for multiplexing with the optical data.

Further exemplary embodiments include an electronic package data encryption method for an electronic package, including generating optical data from electrical data within the electronic package, generating a quantum key distribution signal within the electronic package, multiplexing the optical data and the quantum key distribution signal to generate multiplexed optical data and transmitting the multiplexed optical data from the electronic package.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a high-level system level diagram of an exemplary quantum interconnect system;

FIG. 2 illustrates a system level diagram of an exemplary crypto coprocessor;

FIG. 3 illustrates another system level diagram of an exemplary crypto coprocessor;

FIG. 4 illustrates a quantum interconnect system initialization method in accordance with exemplary embodiments;

FIG. 5 illustrates an example of a quantum state table;

FIG. 6 illustrates a flow chart of an quantum interconnect system run mode method in accordance with exemplary embodiments; and

FIG. 7 illustrates an exemplary embodiment of a system that can support the exemplary quantum interconnect systems and methods described herein.

### DETAILED DESCRIPTION

In exemplary embodiments, the systems and methods described herein implement quantum key distribution (QKD) protocols with optical interconnects between electronic packages to provide a continuously updating cryptographic key along with the ability to determine if an eavesdropper or malicious hardware is present in the path of communications. QKD is thus implemented for data protection for communication at the system/bus level.

QKD involves establishing a key between a sender (“Alice”) and a receiver (“Bob”) by using weak (e.g., 0.1 photon on average) pulsed optical signals transmitted over a “quantum channel.” It will be appreciated that the pulsed optical signals are implemented for attenuated single photon sources. Typically, a true single photon source does not have to be pulsed. It will further be appreciated that establishing a key using optical signals is dependent on Poisson statistics. The security of the key distribution is based on the quantum mechanical principle that any measurement of a quantum system in unknown state will modify its state. As a consequence, an eavesdropper (“Eve”) that attempts to intercept or otherwise measure the quantum signal introduces errors into the transmitted signals and reveals her presence. QKD involves the exchange of single photons encoded with bits of information. The sender and receiver have previously agreed upon a coding basis. Through a classical data channel they establish a set of bits for with they used the same basis for measurement. This bit set is then used as a cryptographic key. The fact that the key stream is composed of photons in a quantum state permits the parties to determine if an eavesdropper exists. It is well known that quantum states cannot be cloned. Additionally, any attempt by an eavesdropper to interrogate the state results in an increase in error rate between the sender and receiver. This increase in error rate informs Alice and Bob that Eve is listening in on the conversation.

Optical interconnects enable light beams or optical signals to be implemented to transmit digital data between electronic packages, both over long distances and between adjacent circuit boards, or on the same circuit board. A light beam may be modulated as needed to carry the quantum encrypted data. The systems and methods described herein implement manipulation of the optical energy that carries the quantum encrypted data for the high-speed low energy communication between electronic packages. The manipulation of an optical signal may include selectively redirecting the light beam of the optical signal to allow detection of the optical signal by a sensor that does not have a direct line of sight with the optical source or to allow detection of the optical signal by more than one sensor.

In exemplary embodiments, the optical beams may be multiplexed or split to reach detectors or other components in different locations on a given circuit board. Consequently, an optical multiplexer or beam splitter may be used as suits a particular application, which can include reducing optical impedance, interference, and/or distortion between electronic packages. For example, optical interconnects can implement wave-length division multiplexing (WDM), which allows wavelengths that emit different color beams into several different ports of a modulator, which allows multiple signals to be transferred concurrently. This multi-wavelength beam travels between electronic packages, with optical switches controlling the direction. In exemplary embodiments, the optical data path originates on the silicon die and remains optically encoded from the die onto a printed circuit board and even across a backplane to another board and ultimately the desired chip. As described further herein, WDM is implemented to provide a data channel and a cryptographic channel that will coexist on the optical interconnects.

As described herein, current tamper resistant electronic protection resistant tamper attempts via erasure of information or burning links to the secure data when interrogated. These solutions do not prevent intrusion detection nor do they prevent reverse engineering though observation of an operating system. In addition, a major threat to system integrity is the incorporation of a malicious package. For example, malicious packages can be inserted when a system is powered down. Current technologies do not detect the presence of an unidentified component or module. The quantum interconnect systems and methods described herein provide a layer of security that is tolerant of power interruptions. As such, the insertion of an additional package changes the error statistics of the key rate exchange between endpoints. The point to point features remain static within the tamper-resistant package. Only a full factory level preset will permit a new component to be introduced to the system. The factory reset will fully erase any closely guarded data.

In exemplary embodiments, data that is encrypted before leaving the tamper-resistant package prevents direct observation of information. The data transaction is synchronous, and encrypted with a dynamically changing key. Synchronous data transmissions keep the bus traffic at a constant rate and the encryption will constantly be changing how the data are represented. The data cannot be compromised without a decryption method capable of keeping up with the rate of key generation.

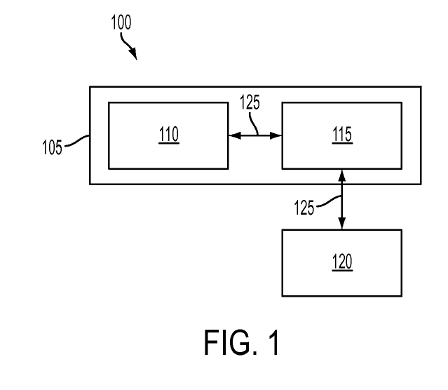

FIG. 1 illustrates a high-level system level diagram of a quantum interconnect system 100 in accordance with exemplary embodiments. The system 100 includes a tamper-resistance electronic package 105 that can include a processor 110 and a crypto-processor 115, which functions as an I/O management subsystem. In exemplary embodiments, the crypto-processor 115 encrypts the data within the tamper-resistance electronic package 105 and interleaves a quantum key protocol (e.g., QKD) signal with the data. All data transactions departing from the tamper-resistance electronic package 105 are optical. It will be appreciated that the tamper-resistant electronic package 105 can be any electronic package that processes data for transfer external to the electronic package. In exemplary embodiments, the tamper-resistance electronic package 105 can be any homogeneous or heterogeneous data package. The processor 110 is shown to illustrate that the tamper-resistance electronic package 105 can be a heterogeneous data package. But, as described above, it can be appreciated that the tamper-resistance electronic package 105 can also be a homogenous data package. The system 100 further includes an external chip 120 to and from which the tamper-resistance electronic package 105 transmits data. For example, the external chip 120 can be a memory chip. As described herein, all components in the system 100 are interconnected by optical interconnects 125.

As further described herein, the system 100 protects tamper-resistance electronic package 105 from reverse engineering and detects the presence of any foreign intrusion or tampering (e.g., from “Eve”). As described herein, current tamper resistant techniques protect individual integrated circuits from intrusion or reverse engineering. The systems and methods described herein not only protect the tamper-resistance electronic package 105 from intrusion or reverse engineering, but also protect the optical interconnects 125 between the tamper-resistance electronic package 105 and other components in the system 100, thereby protecting the system 100 as a whole. The system 100 is extensible to systems of any scale. As such, the system 100 detects malicious hardware intrusion and prevents reverse engineering.

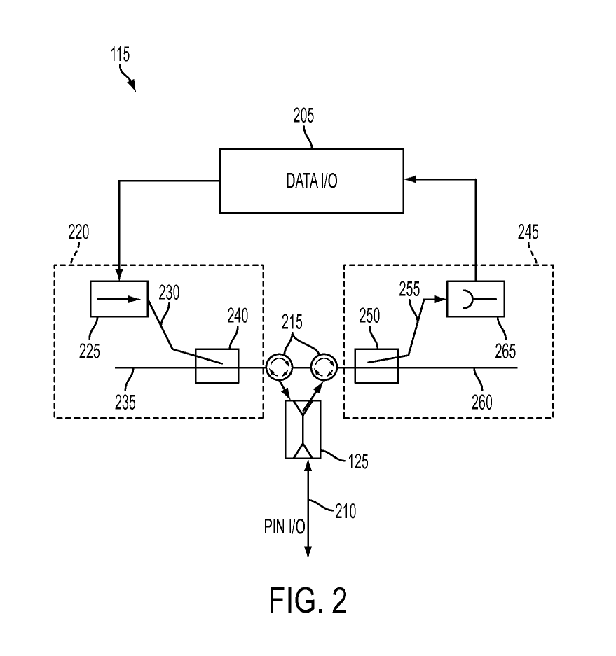

FIG. 2 illustrates an overview of the crypto coprocessor 115 of FIG. 1. The crypto coprocessor 115 can include electrical data I/O 205 that is input and output to and from the tamper-resistance electronic package 105. As illustrated, the electrical data I/O 205 is kept internal to the tamper-resistance electronic package 105, and is converted to optical data I/O as further described herein. The crypto coprocessor 115 also includes an optical interconnect 125, that includes multiplexed optical Pin I/O 210, to and from the tamper-resistance electronic package 105. It will be appreciated that any given electronic package can include multiple optical interconnects and multiple optical Pin I/O. However, FIG. 2 illustrates one channel of many channels. The crypto coprocessor 115 further includes one or more optical circulators 215 coupled to the optical interconnect 125, and configured to separate optical signals travelling in opposite directions, that is, optical data I/O leaving the tamper-resistance electronic package 105, and optical data I/O entering the tamper-resistance electronic package 105.

In exemplary embodiments, the crypto coprocessor 115 further includes a transmitter 220 (“Alice”) and a receiver 245 (“Bob”). In exemplary embodiments, the transmitter 220 is configured to receive the electrical data I/O 205 within the tamper-resistance electronic package 105 and convert it to multiplexed optical Pin I/O 210 for transmission onto the optical interconnect 125. As such, the electrical data I/O 205 is coupled to an optical data source 225 (e.g., a laser) that converts the electrical data I/O 205 to optical data I/O on an optical data I/O path 230. The transmitter 220 further includes a QKD signal on a QKD signal path 235, which is generated as further described herein. The optical data I/O and the QKD signal are multiplexed in a dense WDM (DWDM) 240 and output from the transmitter 220 to the optical circulator 215 for transmission on the optical interconnect 125 as the multiplexed optical Pin I/O 210 transmitted external to the tamper-resistance electronic package 105. As described herein, the optical data I/O and the QKD signal are generated at different wavelengths. For example, the optical data I/O can be 840 nm and the QKD signal can be 800 nm. The wavelength separation between the optical data I/O and the QKD signal will depend on the bandwidth of the data channel and the ability to provide a >30 dB isolation between data and quantum channels. In addition, as described further herein, the encryption key implemented in the QKD signal changes frequently (e.g., at a rate of 1 kHz).

In exemplary embodiments, the receiver 245 is configured to receive the multiplexed optical Pin I/O 210 in the tamper-resistance electronic package 105 from the optical interconnect 125. The multiplexed optical Pin I/O 210 is received through the optical circulator 215, which diverts the multiplexed optical Pin I/O 210 into a DWDM 250, separating the multiplexed optical Pin I/O 210 into optical data I/O and an optical data I/O path 255 and a QKD signal on a QKD signal path 260. The optical data I/O is received in an optical receiver 265 that converts the optical data I/O into the electrical data I/O 205. As described herein, the optical data I/O and the QKD signal are generated, and thus also received, at different wavelengths. For example, the optical data I/O can be 840 nm and the QKD signal can be 800 nm. The wavelength separation between the optical data I/O and the QKD signal will depend on the bandwidth of the data channel and the ability to provide a >30 dB isolation between data and quantum channels. In addition, as described further herein, the encryption key implemented in the QKD signal changes frequently (e.g., at a rate of 1 kHz).

In exemplary embodiments, key material for the QKD encryption is thus exchanged and processed at both the transmitter 220 and the receiver 245 using the QKD quantum protocol. As such, the key material is used to encode transactions between one or more tamper resistance electronic packages. In this way, the optical data I/O and the QKD signal share the same channel. In addition, the change rate of the QKD signal combined with a synchronous data transfer protocol randomizes data transactions such that no data patterns will be visible to a probe. In addition, the implementation of QKD permits the detection of an eavesdropper or an addition of any third party element as described herein. All data transactions in the system are now protected. Data transactions between sensors, FPGA, and multiple CPUs, and other types of electronic packages, is encrypted and authenticated. The addition of a new processing element into the data path would require authentication to the entire system and could only be done in a secure environment with a priori knowledge of the initial authentication sequence, which prevents power down and insertion of new components. Local key repositories would be updated at the change rate requiring the crypto coprocessor 115 to decrypt. During operation, probing of the optical data bus would result in a disruption of key exchange that would indicate an intruder, thereby providing previously unavailable protection against insertion of foreign and potentially malicious components.

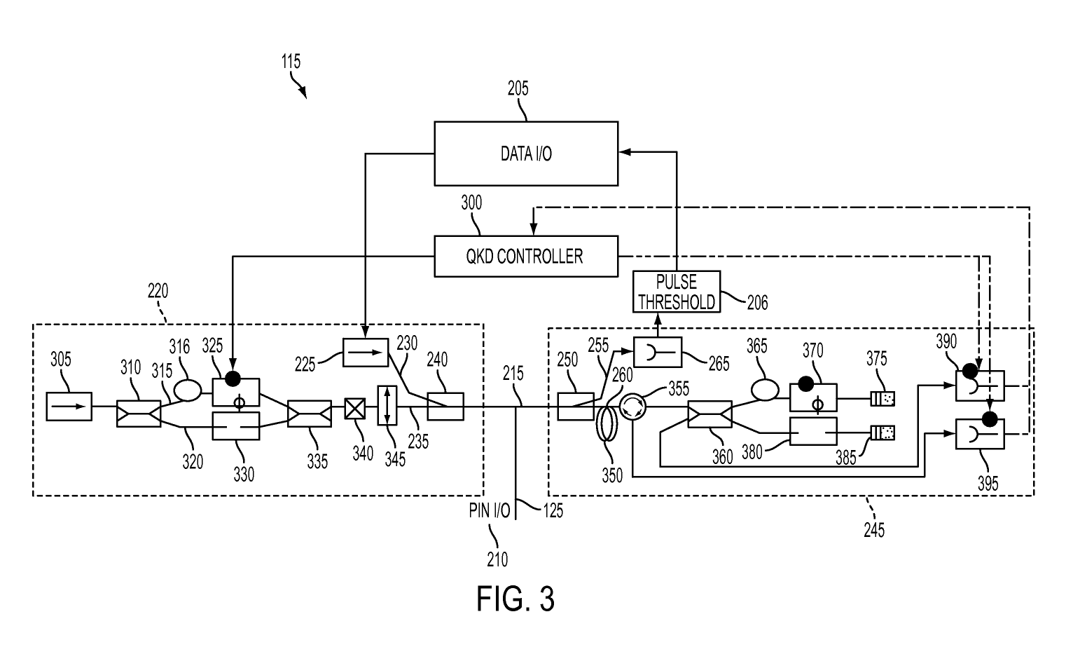

FIG. 2 illustrates generalized QKD signals for illustrative purposes. It can be appreciated that the QKD signals can be generated by various QKD protocols, including but not limited to the BB84 quantum key distribution scheme. In addition, the photons for the QKD signals can be generated by various methods. One such method is phase entanglement of single photons. It will be appreciated that other types of methods can be used to generate the photons, such as but not limited to quantum entanglement of other properties of photons, including, but not limited to position, momentum, spin and polarization. FIG. 3 illustrates the crypto coprocessor 115 of FIGS. 1 and 2 showing an example of QKD signal generation via phase entanglement of single photons. It will be appreciated that FIG. 3 illustrates only one example of how the QKD signal photons can be generated.

As described above with respect to FIG. 2, the crypto coprocessor 115 includes electrical data I/O 205 that is input and output to and from the tamper-resistance electronic package 105. A pulse threshold controller 206 sets the rate at which the optical data I/O from the optical receiver 265 is converted. The electrical data I/O 205 is kept internal to the tamper-resistance electronic package 105, and is converted to optical data I/O. The crypto coprocessor 115 also includes an optical interconnect 125, that includes multiplexed optical Pin I/O 210, to and from the tamper-resistance electronic package 105. The crypto coprocessor 115 further includes one or more optical circulators 215 coupled to the optical interconnect 125, and configured to separate optical signals travelling in opposite directions, that is, optical data I/O leaving the tamper-resistance electronic package 105, and optical data I/O entering the tamper-resistance electronic package 105. The crypto coprocessor 115 also includes a QKD controller 300 configured to establish the keys for the transmitter 220 and the receiver 245.

In exemplary embodiments, the crypto coprocessor 115 further includes a transmitter 220 and a receiver 245. In exemplary embodiments, the transmitter 220 is configured to receive the electrical data I/O 205 within the tamper-resistance electronic package 105 and convert it to multiplexed optical Pin I/O 210 for transmission onto the optical interconnect 125. As such, the electrical data I/O 205 is coupled to an optical data source 225 (e.g., a laser) that converts the electrical data I/O 205 to optical data I/O 230. The transmitter 220 further includes the QKD signal 235. The optical data I/O 230 and the QKD signal 235 are multiplexed in a DWDM 240 and output from the transmitter 220 to the optical circulator 215 for transmission on the optical interconnect 125 as the multiplexed optical Pin I/O 210 transmitted external to the tamper-resistance electronic package 105. As described herein, the optical data I/O 230 and the QKD signal 235 are generated at different wavelengths. For example, the optical data I/O 230 can be 840 nm and the QKD signal can be 800 nm. The wavelength separation between the optical data I/O and the QKD signal will depend on the bandwidth of the data channel and the ability to provide a >30 dB isolation between data and quantum channels. In addition, as described further herein, the encryption key from the QKD controller 300, and implemented in the QKD signal changes frequently (e.g., at a rate of 1 kHz).

As described herein, the example illustrated in FIG. 3 generates QKD photons implementing phase entanglement of single photons. The transmitter 220 further includes a QKD optical source 305 (e.g., a laser), which as described herein can generate signals at a particular wavelength (e.g., 800 nm) differing from the wavelength of the optical data I/O. The QKD optical source 305 is coupled to an optical coupler 310 in order to split photons generated by the QKD optical source 305 into two photon paths 315, 320. Quantum entanglement of the photons from the QKD optical source 305 is achieved by splitting the photons, which are at first interacting physically with one another, and separating the photons into the two photon paths. When the photons are separated by the optical coupler 310, each respective group of photons has the same quantum mechanical description (i.e. state). Phase entanglement is then achieved by altering the phases of the photons in the respective photon paths 315, 320. In the example, the photons in the photon path 315 is subject to a delay loop 316 and then input into an electro-optical phase shifter 325, which is coupled to the QKD controller 300. As such, the photons in the electro-optical phase shifter 325 are coded with the key material from the QKD controller 300. The photons in the photon path 320 are input into an adjustable air gap delay 330, thereby altering the phase of the original photons from the QKD optical source 305. The photons from the electro-optical phase shifter 325 and the adjustable air gap delay 330 are then recombined in an optical coupler 335. As described above, the recombination of the photons from the electro-optical phase shifter 325 and the photons from the adjustable air gap delay 330 share the same quantum state. However, due to the respective phase shifts, the phases of the photons are indefinite, thus creating phase entanglement. In addition, the key material from the QKD controller 300 is associated with the photons in the optical coupler 335. Therefore, subsequent measurements made to a single member of the combined photons has correlated values (e.g., of the phase) of other members of the entangled photons. As such, there is a correlation between the results of measurements performed on entangled photons, and this correlation is observed even though the entangled photons may have been separated by arbitrarily large distances. An optical attenuator 340 can then statistically reduce the mean photon number to some value less than or equal to 1. The actual mean photon value depends on a mathematical analysis of the system in which the electronic package 105 resides, and attack vulnerabilities. A polarizer 345 can be implemented to set the polarization of the photon before it is input to the QKD signal path 235. It can be appreciated that the optical data I/O is thus combined with a single phase entangled photon that contains the key material, which is then input on the optical interconnect 125 as the multiplexed optical Pin I/O 210.

Referring still to FIG. 3, in exemplary embodiments, the receiver 245 is configured to receive the multiplexed optical Pin I/O 210 in the tamper-resistance electronic package 105 from the optical interconnect 125. The multiplexed optical Pin I/O 210 is received through the optical circulator 215, which diverts the multiplexed optical Pin I/O 210 into a DWDM 250, separating the multiplexed optical Pin I/O 210 into optical data I/O onto an optical data I/O path 255 and a QKD signal (in this example a single phase entangled photon) onto a QKD signal path 260. The optical data I/O is received in an optical receiver 265 that converts the optical data I/O into the electrical data I/O 205, the rate of which can be controlled by the pulse threshold controller 206. As described herein, the optical data I/O and the QKD signal are generated, and thus also received, at different wavelengths. For example, the optical data I/O can be 840 nm and the QKD signal can be 800 nm. In addition, as described further herein, the encryption key from the QKD controller 300 and implemented in the QKD signal changes frequently (e.g., at a rate of 1 kHz).

As described herein, the example illustrated in FIG. 3 generates QKD photons implementing phase entanglement of single photons. In addition, the receiver 245 is configured to receive QKD photons implementing phase entanglement of single photons from another source (e.g., another electronic package). As described herein, the attenuator 340 statistically reduces the mean photon number to some value less than or equal to 1. The actual mean photon value depends on a mathematical analysis of the system and attack vulnerabilities. It can be appreciated that similar configurations of the transmitter 220 and receiver 245 are implemented in other electronic packages that communicate with the tamper-resistance electronic package 105. As such, at the receiver 245, the same conditions as the transmit side must be met to get a positive value for the mean photon number. As such, when the receiver 245 receives a photon from another electronic package, the photon is processed under the same conditions. As such, a photon is received from the multiplexed optical Pin I/O 210 into the circulator 215 that directs the photon into the DWDM 250. The optical data I/O is processed as described herein. The photon (i.e., the QKD signal) is input into a delay loop 350 and then directed into a circulator 260 that directs the incoming photon to an optical coupler 360. As described herein, the phase entangled photons include a correlation to the other entangled photons. As such, if the photon was subject to the delay loop 316 and the electro-optical phase shifter 325 in the transmitter 220 (or similar transmitter on a different electronic package), then the photon is directed out of the optical coupler 360 to a delay loop 365 and an electro-optical phase shifter 370. The photon is then reflected from a faraday mirror 375, and travels back through the optical phase shifter 370, the delay loop 365 and the optical coupler 360. When the photon is input into the circulator 260, the photon is directed to a QKD optical receiver 395. If the photon was subject to the adjustable air gap delay 330 in the transmitter 220 (or similar transmitter on a different electronic package), then the photon is directed out of the optical coupler 360 to an adjustable air gap delay 380. The photon is then reflected from a faraday mirror 385, and travels back through the adjustable air gap delay 380 and the optical coupler 360. When the photon is input into the circulator 260, the photon is directed to a QKD optical receiver 390. Regardless of the photon path, as described herein, the photon is polarized by a polarizer (e.g., the polarizer 345 in the transmitter 220). The faraday mirrors allow the photon to maintain its polarization and to compensate for any induced phase changes through the respective paths. The QKD controller 300 is coupled to the QKD optical receivers 390, 395, thereby being able to read the key material of the photon. As such, the QKD controller can confirm that the transmitted key material matches the received key material.

In exemplary embodiments, the systems described herein can be implemented for secure communication between electronic packages sharing a common bus (e.g., an optical bus interconnected by the optical interconnects described herein). For example, the transmitters of several electronic packages prepare a photon from a predetermined basis set. For this example the basis set is a discrete number of phases alternatively. As described herein, other properties of the photon can also be implemented in the basis set, including, but not limited to position, momentum, spin and polarization. In addition, the receivers choose a basis for measurement at random. The value the receivers measure may be a yes (1) or no (0). The transmitters and receivers communicate over the classical channel to determine when they have both chosen the same basis. The bit stream resulting from the same basis choices forms the encryption key used at both ends.

In exemplary embodiments, the system 100 undergoes a system initialization to establish communications paths among electronic devices. Once the communication paths are established, the system 100 enters a run mode.

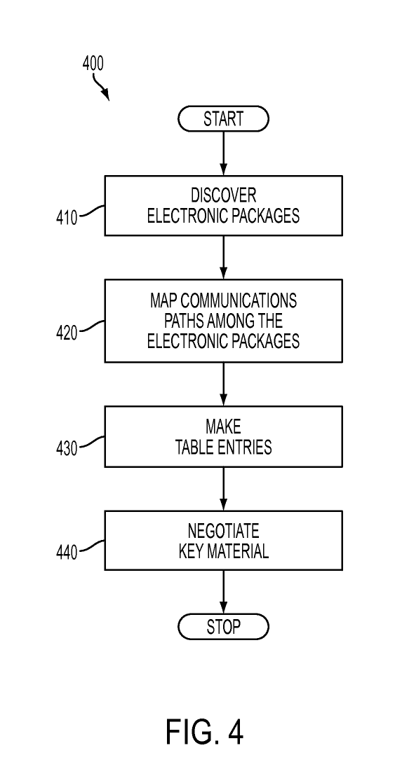

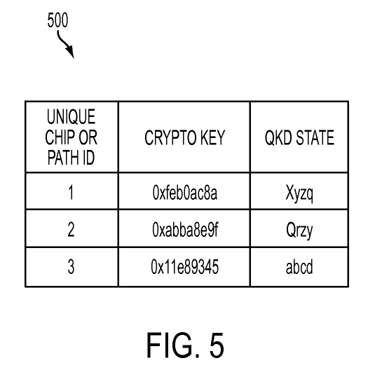

FIG. 4 illustrates a quantum interconnect system initialization method 400 in accordance with exemplary embodiments. At system initialization all the electronic packages on the optical bus will have a predetermined key used for authentication and encryption. All electronic packages have a table containing the communications endpoint keys. Key establishment must insert data packets into the data stream to complete. As described herein, the encryption keys provide secure point to point (P2P) communications. At block 410, each electronic package goes through a discovery process by traversing the list of known endpoints and using the QKD channel to establish a new cryptographic key used for P2P data transactions. The establishment of the cryptographic key proceeds as described herein, via the QKD protocol (e.g., BB84). In addition, at block 420, the electronic packages make a mapping is made of all the electronic packages that wish to communicate with one another. The cryptographic keys are stored locally at each endpoint (e.g., a memory device coupled to the electronic package). For each communication path, at block 430, an entry is made into the table to hold the quantum key distribution state (e.g., key statistics, key material etc.) In addition, at block 440 each of the electronic packages negotiates the key material on each table path. FIG. 5 illustrates an example of a table 500 that stores a unique chip ID or path ID, the associated crypto key and the QKD state.

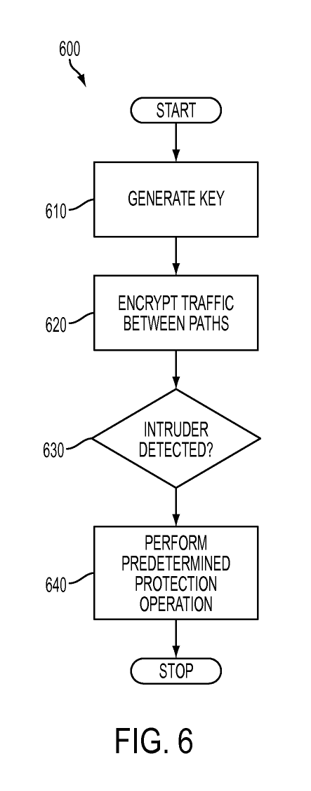

After initialization, the crypto coprocessor 115 then enters a run mode. FIG. 6 illustrates a flow chart of a quantum interconnect system run mode method 600 in accordance with exemplary embodiments. During the run mode, at block 610 a key is generated as part of every data exchange between electronic packages. During the key generation process, any eavesdropper would be detected by an increase of error rate in the key generation. As such, detection of external data probing results in an increase of error rate in the key generation. The cryptographic key is continuously generated and used to detect the presence of an intruder, and further protect the data by encryption key update. In addition, as described herein, the key length is determined by the rate of key production and the likelihood that the key length will be compromised by traditional key breaking methods, which establishes a definitive upper bound on the protection offered. At block 620, once a new key is established between data paths it would be used to encrypt traffic between the labeled path. At block 630, the system automatically detects an intruder by the increase of error rate as described herein. If there is no intruder detected at block 630, then the method continues at block 610. IF an intruder is detected at block 630, then at block 640, the system 100 performs a pre-determined protection operation such as shut down or erasure of protected data.

Each electronic package can further include a classical processing unit such as an analog to digital converter, a central processing unit (e.g., the processor 110), memory element (e.g., the chip 120), along with a cryptographic coprocessor (e.g., the crypto coprocessor 115). As described herein, the cryptographic coprocessor includes several functions, including, but not limited to: 1) encrypting the incoming and outgoing data; 2) managing the QKD protocol for key generation, privacy amplification and error detection; 3) executing a predefined intrusion sequence; 4) maintaining the table of trusted partners and their keys; and 5) performing the electrical to optical conversion of data I/O.

In exemplary embodiments, communications topology is retained in the tamper resistant electronic packages during power off. The resulting power on would be a bit different from initial authentication in that each endpoint would know the specifics of the channels of its partner endpoints (e.g. their unique cryptographic key). Before the system would start any processing all optical interconnect paths would be validated by performing a key exchange. The efficacy of the exchange would be compared with statistics from previous exchanges. Any errors that significantly deviation from the known channel properties would indicate that a third party device was inserted.

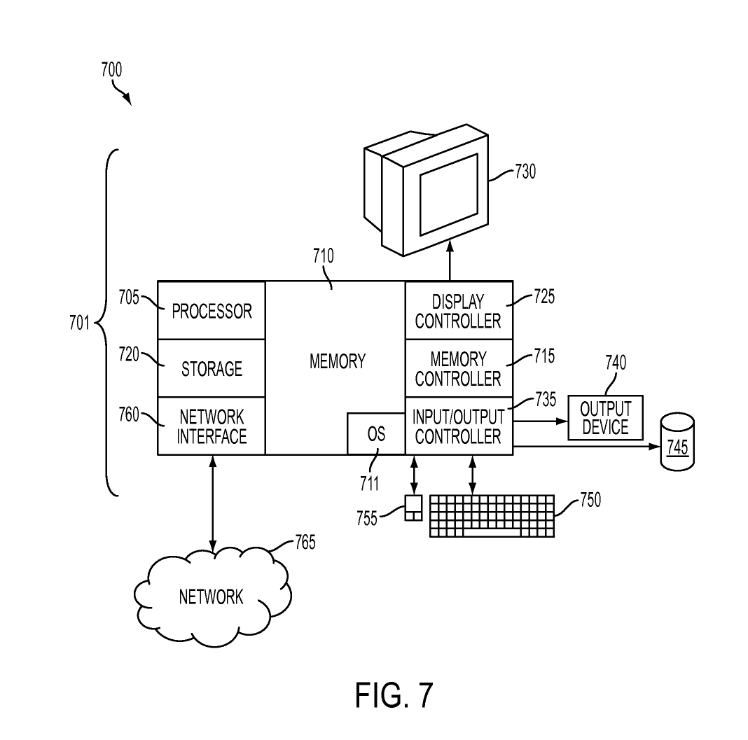

It can be appreciated that the exemplary quantum interconnect tamper resistant packages described herein can be implemented in any type of computing system. In addition, the processors and crypto coprocessors can be any suitable processor. As such, a computing system is now described. FIG. 7 illustrates an exemplary embodiment of a system 700 that can support the exemplary quantum interconnect systems and methods described herein. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 700 therefore includes general-purpose computer 701.

In exemplary embodiments, in terms of hardware architecture, as shown in FIG. 7, the computer 701 includes a processor 705, memory 710 coupled to a memory controller 715, and one or more input and/or output (I/O) devices 740, 745 (or peripherals) that are communicatively coupled via a local input/output controller 735. The input/output controller 735 can be, but is not limited to, one or more buses or other wired or wireless connections, as is known in the art. The input/output controller 735 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 705 is a hardware device for executing software, particularly that stored in memory 710. The processor 705 can be any custom made or commercially available processor, a central processing unit (CPU), an auxiliary processor among several processors associated with the computer 701, a semiconductor based microprocessor (in the form of a microchip or chip set), a macroprocessor, or generally any device for executing software instructions.

The memory 710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, and/or other types of storage media. Note that the memory 710 can have a distributed architecture, where various components are situated remote from one another, but can be accessed by the processor 705.

The software in memory 710 may include one or more separate programs, each of which comprises an ordered listing of executable instructions for implementing logical functions. In the example of FIG. 7, the software in the memory 710 includes the quantum interconnect methods described herein in accordance with exemplary embodiments and a suitable operating system (OS) 711. The OS 711 essentially controls the execution of other computer programs, such the quantum interconnect systems and methods as described herein, and provides scheduling, input-output control, file and data management, memory management, and communication control and related services.

The quantum interconnect methods described herein may be in the form of a source program, executable program (object code), script, or any other entity comprising a set of instructions to be performed. When a source program, then the program needs to be translated via a compiler, assembler, interpreter, or the like, which may or may not be included within the memory 710, so as to operate properly in connection with the OS 711. Furthermore, the quantum interconnect methods can be written as an object oriented programming language, which has classes of data and methods, or a procedure programming language, which has routines, subroutines, and/or functions.

In exemplary embodiments, a conventional keyboard 750 and mouse 755 can be coupled to the input/output controller 735. Other output devices such as the I/O devices 740, 745 may include input devices, for example but not limited to a printer, a scanner, microphone, and the like. Finally, the I/O devices 740, 745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 700 can further include a display controller 725 coupled to a display 730. In exemplary embodiments, the system 700 can further include a network interface 760 for coupling to a network 765. The network 765 can be an IP-based network for communication between the computer 701 and any external server, client and the like via a broadband connection. The network 765 transmits and receives data between the computer 701 and external systems. In exemplary embodiments, network 765 can be a managed IP network administered by a service provider. The network 765 may be implemented in a wireless fashion, e.g., using wireless protocols and technologies, such as WiFi, WiMax, etc. The network 765 can also be a packet-switched network such as a local area network, wide area network, metropolitan area network, Internet network, or other similar type of network environment. The network 765 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 701 is a PC, workstation, intelligent device or the like, the software in the memory 710 may further include a basic input output system (BIOS) (omitted for simplicity). The BIOS is a set of essential software routines that initialize and test hardware at startup, start the OS 711, and support the transfer of data among the hardware devices. The BIOS is stored in ROM so that the BIOS can be executed when the computer 701 is activated.

When the computer 701 is in operation, the processor 705 is configured to execute software stored within the memory 710, to communicate data to and from the memory 710, and to generally control operations of the computer 701 pursuant to the software. The quantum interconnect methods described herein and the OS 711, in whole or in part, but typically the latter, are read by the processor 705, perhaps buffered within the processor 705, and then executed.

When the systems and methods described herein are implemented in software, as is shown in FIG. 7, the methods can be stored on any computer readable medium, such as storage 720, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the quantum interconnect methods are implemented in hardware, the quantum interconnect methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for resisting tampering, the method comprising:
discovering a plurality of electronic packages for communication, each of the plurality of electronic packages having an associated quantum state table;
mapping a plurality of communications paths among the plurality of electronic packages;
for each communication path of the plurality of communications paths, making an entry into the quantum state table;
negotiating key material for each of the plurality of communications paths;
for a plurality of data exchanges along each of the plurality of communications paths:
generating a key; and
encrypting a data exchange on a communications path with the key.

2. The method as claimed in claim 1, wherein the entry into the quantum state table is a quantum key distribution state.

3. The method as claimed in claim 1 further comprising monitoring an error rate of communication for each of communications path of the plurality of communications paths.

4. The method as claimed in claim 3, further comprising performing a predetermined protection operation in response to a detection an increase in the error rate, the increase in the error rate being indicative of an intrusion in the communications path.

5. The method as claimed in claim 1 wherein the key is encoded into an optical signal to generate a quantum key distribution (QKD) signal.

6. The method as claimed in claim 5 wherein the data exchange includes an optical data signal.

7. The method as claimed in claim 6 wherein the QKD signal is multiplexed with the optical data signal to generate multiplexed optical data.

8. The method as claimed in claim 8 wherein the multiplexed optical data is exchanged on one or more of the plurality of communications paths.

9. The method as claimed in claim 1 wherein the plurality of communications paths are along optical interconnects.

10. A tamper resistant electronic package system, comprising:
a crypto coprocessor, including:
a transmitter configured to generate optical data;
a receiver coupled to and configured to exchange electrical data between the transmitter, and to generate the electrical data from one or more sources of multiplexed optical data; and
a quantum key distribution (QKD) controller coupled to the transmitter and the receiver, the QKD controller configured to generate a key for multiplexing with the optical data.

11. The system as claimed in claim 10 further comprising an optical interconnect coupled to the transmitter and the receiver, the optical interconnect configured to support the multiplexed optical data.

12. The system as claimed in claim 10 wherein the transmitter comprises:
an optical data source configured to generate the optical data from the electrical data;
a QKD optical source configured to generate a QKD signal that is encoded with the key.

13. The system as claimed in claim 12 wherein the transmitter is further configured to multiplex the optical data and the QKD signal.

14. The system as claimed in claim 12 wherein the QKD signal is generated via quantum entanglement.

15. The system as claimed in claim 10 wherein the receiver comprises:
an optical data receiver configured to receive optical data from the one or more sources of multiplexed optical data;
a QKD optical receiver configured to receive a QKD signal from the one or more sources of multiplexed optical data.

16. The system as claimed in claim 15 wherein the receiver is configured to separate the optical data and the QKD signal from the one or more sources of multiplexed optical data.

17. An electronic package data encryption method for an electronic package, comprising:
generating optical data from electrical data within the electronic package;
generating a quantum key distribution (QKD) signal within the electronic package;
multiplexing the optical data and the QKD signal to generate multiplexed optical data; and
transmitting the multiplexed optical data from the electronic package.

18. The method as claimed in claim 17 wherein the QKD signal is generated from a group of photons that has been encoded with a key.

19. The method as claimed in claim 18 wherein the group of photons is generated by quantum entanglement of one or more properties of the group of photons.

20. The method as claimed in claim 19 wherein the group of photons is prepared from a predetermined basis set based on the one or more properties of the group of photons.
